(19) United States
(12) Patent Application Publication
(10) Pub. No.: US 2023/0230037 A1
(43) Pub. Date: Jul. 20, 2023

(54) EXPLAINABLE CANDIDATE SCREENING CLASSIFICATION FOR FAIRNESS AND DIVERSITY

(71) Applicant: Dell Products L.P., Round Rock, TX (US)

(72) Inventors: Adriana Bechara Prado, Niterói (BR); Paulo Abelha Ferreira, Rio de Janeiro (BR)

(21) Appl. No.: 17/648,509

(22) Filed: Jan. 20, 2022

(51) Int. Cl. G06Q 10/10

(52) U.S. Cl. CPC G06Q 10/1053

(57) ABSTRACT

One example method includes receiving, at a decision tree trained with a group of training observations, a group of new observations, traversing the decision tree with the new observations, calculating, for one or more nodes of the decision tree, a respective local diversity score, and aggregating the local diversity scores to create an aggregate diversity score, and the aggregate diversity score indicates an extent to which one or more of the new observations are similar, in one or more respects, to the group of training observations.

### FIELD OF THE INVENTION

Embodiments of the present invention generally relate to processes for candidate screening, such as in an employment context. More particularly, at least some embodiments of the invention relate to systems, hardware, software, computer-readable media, and methods for enabling an organization to build its own explainable machine learning models for candidate screening that, besides being interpretable by nature, quantify how different a candidate being evaluated is with respect to current employees of the organization.

### BACKGROUND

Predicting the success of future employees based on outcomes associated with current employees, as is done with custom algorithmic pre-employment assessments, potentially reduces the chance of increasing diversity because hiring new candidates inherently skews the task toward finding candidates resembling those who have already been hired. Indeed, few organizations disclose specifics on how these tools perform for a diverse group of applicants, such as with respect to gender, ethnicity, race, and age, for example, and if/how the organization is able to select a diverse pool of candidates in an explainable and fair way. Also, organizations may be shielded by intellectual property laws, and so may not be compelled to disclose the specifics of how their assessment models are configured, and operate. However, some level of transparency is necessary to enable better evaluations of these tools and the results that they produce.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses aspects of an example regression decision tree.

FIG. 2 discloses a dataset with outliers.

FIG. 3 discloses an example decision tree node according to some embodiments.

FIG. 4 discloses a configuration of multiple decision tree nodes and associated datasets.

FIG. 5 discloses a configuration for determining LDS values, and D values, according to some embodiments.

FIG. 6 discloses an example method for determining LDS values and a corresponding D value.

FIG. 7 discloses aspects of an example computing entity operable to perform any of the disclosed methods, processes, and operations.

### DETAILED DESCRIPTION OF SOME EXAMPLE EMBODIMENTS

Embodiments of the present invention generally relate to processes for candidate screening, such as in an employment context. More particularly, at least some embodiments of the invention relate to systems, hardware, software, computer-readable media, and methods for enabling an organization to build its own explainable machine learning models for candidate screening that, besides being interpretable by nature, quantifies how different a candidate being evaluated is with respect to current employees of the organization.

In general, example embodiments of the invention are directed to approaches for candidate screening. Such embodiments may operate to implement a fair screening strategy that leads to a diverse pool of candidates to be considered. More particularly, embodiments are directed to approaches for bringing transparency to algorithmic pre-employment assessments, as well as giving to their users the ability to evaluate how different new observations, that is, candidates, compare with the observations, that is, current employees, that are used to train the machine learning model in question. Some specific embodiments are directed to models based on decision trees, as self-explaining models, and embodiments may further employ an outlier detection scheme which, at prediction time, quantifies how different a candidate being evaluated is in comparison with the employees in the training set which traverse the same path in the decision tree. Such diverse score can also be regarded as a measure of how confident the company in question might be with respect to the predictions given by the ML model.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of at least some embodiments of the invention is that an organization may be able to explain their hiring decisions in a credible way without having to reveal the structure and operation of the algorithm that the organization uses to screen candidates. Various other advantages of example embodiments of the invention will be apparent from this disclosure.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

A. Overview

There has been growing interest in the use of algorithms for hiring, in particular as a means to mitigate fairness issues. According to the literature, there are four main distinct stages of the hiring pipeline: sourcing, screening, interviewing, and selection. Sourcing consists of building a candidate pool, which is then screened to choose a subset to interview. Example embodiments of this invention are concerned with, among other things, candidate screening. Particularly, embodiments may provide a fair screening strategy that leads to a diverse pool of candidates to be considered.

With the current advent of machine learning (ML) in many different areas, it is no surprise that candidate screening is currently also being automated. One example of such automation is the selection of candidates based on a selected number of competencies, which are evaluated and quantified by algorithmic pre-employment assessments. According to one recent study on the subject, the most popular assessment types are questions, video interview analysis, and gameplay, such as by way of puzzles or video games. See “Mitigating Bias in Algorithmic Hiring: Evaluating Claims and Practices,” M. Raghavan and Solon Barocas and Jon M. Kleinberg and Karen E. C. Levy. Proceedings of the Conference on Fairness, Accountability, and Transparency, 2020 (“Mitigating Bias”). For video interviews, candidates are typically asked to record answers to particular questions and then the video transcripts are analyzed by the tools, which provide scores for several competencies. In the case of question-based assessments, examples of such assessments include personality tests, and situational judgments tests, for example. Finally, some organizations offer games aiming at evaluating specific competencies, such as ‘numerical agility.’

Typically (see “Mitigating Bias”), vendors offer custom, or pre-built, algorithmic pre-employment assessments. At least some example embodiments of the invention are particularly focused on the former. Generally speaking, in the case of a custom assessment, a given company, as the client of the vendor that produces the algorithm, may ask their employees to take the assessment, and then, as a second step, link the assessment results to performance scores of the same employees, such as sales number for example. In this way, training data is acquired, in which the assessment results serve as features, and a performance score serves as a target attribute. Here, the notion is that the final ML model will learn, from this training data, the relationships between employee performance scores and their assessment results. In other words, the ML model will be able to predict how a given candidate would perform in the company in question, given his/her assessment results.

One of the concerns brought up by researchers in the field (see “Mitigating Bias”) is that by predicting the success of future employees based on current employees, one may skew the task toward finding candidates similar to those who have already been hired and this, in turn, may potentially reduce the chance of increasing diversity in the candidate pool. Indeed, according to one study, very few vendors disclose specifics on how these tools perform for a diverse group of applicants, with respect to applicant attributes such as gender, ethnicity, race, and age, for example, and also do not disclose if/how they are able to select a diverse pool of candidates in an explainable and fair way. In addition, vendors are shielded by intellectual property laws, so companies may not be compelled to disclose any information about their models and how their internals work. More transparency is necessary to better evaluate these tools.

B. Concepts Relating to Example Embodiments

B.1 Regression Decision Trees

As noted earlier herein, example embodiments of the invention are directed to training an ML-based predictor to predict performance scores of candidates in an explainable way, having their competencies scores as input. Following is a brief overview of an example ML model that may be applied in the context of at least some example embodiments of the invention.

At least some example embodiments pertain particularly to a specific ML task referred to as ‘supervised regression,’ which generally involves regressing, or inferring, a numeric output value, such as a performance score, from one or more input values, such as competencies scores. Accordingly, embodiments of the invention may employ a dataset containing various examples of input values linked to their corresponding output values. The next task is then to learn a mapping that accurately moves from the input to the output. This learning may be done during what may be referred to herein as a ‘training stage’ and may use what is referred to herein as a ‘training dataset.’ Accuracy may be defined by way of a metric defined a priori that takes in a ‘test dataset’ that has never been seen during the training stage.

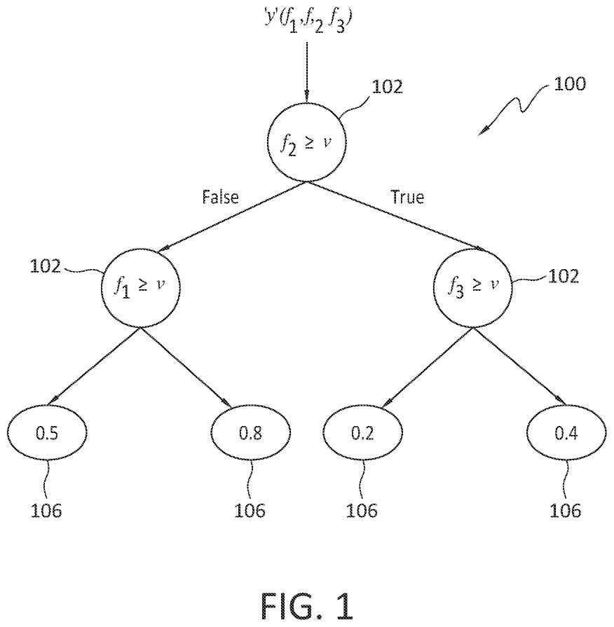

Some example embodiments may be particularly concerned with the prediction of a performance score, which may comprise a single output numeric value, based on competencies' scores evaluated by algorithmic pre-employment assessments, that is, input values. For a single input value, each one of its attributes is referred to as a ‘feature.’ One example of an ML model that can perform such tasks is a regression decision tree. In general, a decision tree runs the input through a series of questions regarding features' values until the input ends up in a leaf of the decision tree. This leaf contains the predicted output value corresponding to the given input. One example of a regression decision tree is denoted generally at 100 in FIG. 1.

For the purposes of illustration, and with reference to FIG. 1, assume an input ‘y’ having three attributes, or features, denoted f₁, f₂, and f₃. To predict a numerical value associated to ‘y,’ such input runs through the regression decision tree 100, which may include various nodes 102 that each correspond to a respective inequality test which are binary in nature. In the example of FIG. 1, the inequality tests are f₂≥v, f₁≥v, and f₃≥v. When the answer to an inequality test is ‘false,’ traversal of the regression decision tree 100 proceeds to the left in FIG. 1, and when the answer to an inequality test is ‘true,’ traversal of the regression decision tree 100 proceeds to the right in FIG. 1. Each inequality test directs the input towards a subset of internal nodes until a leaf 106 is reached. Example embodiments of the invention may employ regression decision trees as an ML model. Use of mechanisms such as regression decision trees may be advantageous due to their inherently explainability. That is, given a regression decision tree, such as the example in FIG. 1, it can readily be seen, by following a traversal of the regression decision tree, how a decision, outcome, or conclusion, was reached.

B.2 Outliers

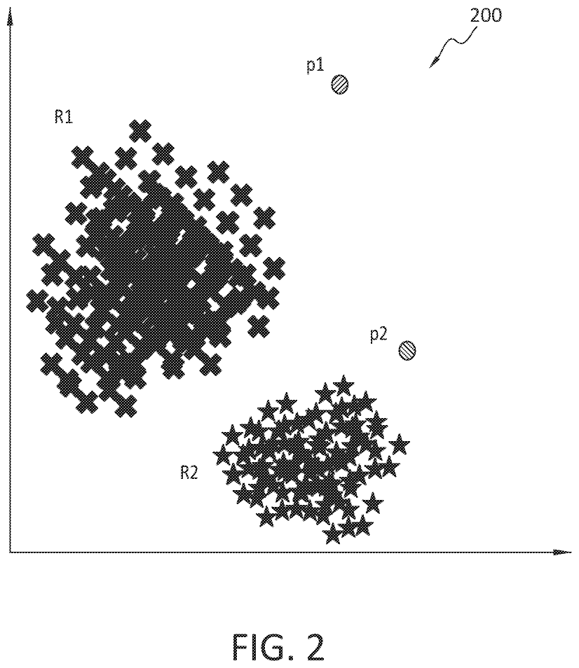

As used herein, an ‘outlier’ is a data point that is significantly different from the remaining data in a set to which the outlier belongs. Another definition found in the literature is “An outlier is an observation which deviates so much from the other observations as to arouse suspicions that it was generated by a different mechanism.” FIG. 2 includes a graph 200 that illustrates the definition of outliers in a 2D example. See “Anomaly Detection—A Survey,” V. Chandola, A. Banerjee, and V. Kumar. ACM Computing Surveys 41 (3): 1-58 (July 2009). As shown, most of the points of interest lie in one of the ‘normal’ regions R₁ or R₂. Points that lie far away from R₁ and R₂ are considered outliers, that is, points p₁ and p₂.

Outliers are also referred to as anomalies in the ML literature. In many domains, data is generated by one or more processes. They can represent a certain activity of a certain system or they can be observations that are collected about some entity. When such processes behave in an unusual way, they can result in the generation of outliers. Therefore, an outlier often contains useful information about abnormal characteristics of the systems and entities which impact the data generation process. Example embodiments may employ the idea of outliers as a mechanism to quantify how a candidate being evaluated by a company differs with respect to the current employees of the company, and how confident the company might be with respect to the predictions generated by the ML model.

C. Detailed Aspects of Some Example Embodiments

In general, example embodiments of the invention may assume that a decision tree model is trained from a set of observations O={o₁, o₂, o₃, . . . , oₙ} referred to herein as a training dataset. An example of an ‘observation’ is a candidate for a given job position. Thus, in the preceding illustration, o₁, o₂, and o₃ each identify, or at least correspond to, a different respective candidate. Further, each observation in such a training dataset may comprise a set of features F={f₁, f₂, f₃, . . . fₘ}. Each of the features F may correspond to a respective competency score achieved by a given candidate with respect to a particular competency, such as word processing, or Java coding, for example, where the competency scores may be evaluated by algorithmic pre-employment assessments.

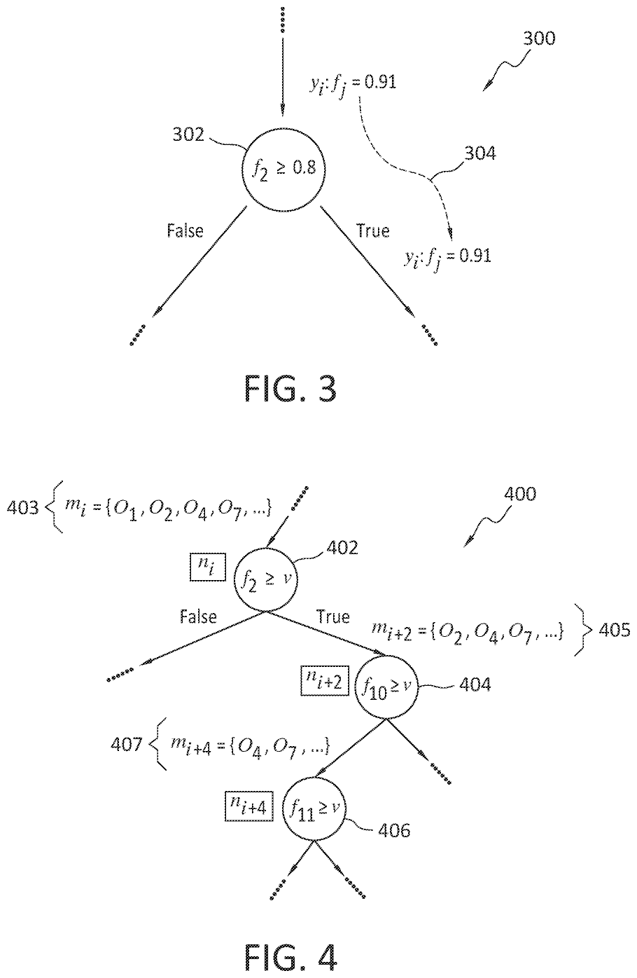

As noted earlier herein, a decision tree, such as a regression decision tree, is a binary tree comprising a set of nodes N={n₁, n₂, n₃, . . . nₖ}, where each node represents an inequality test over a feature fⱼ. In order to predict the output, such as a performance score for example, of a given new observation yᵢ, that is of a given job candidate, one method runs yᵢ through a series of inequality tests until yᵢ, that is, the candidate, ends up at a particular leaf of the decision tree. The leaf may correspond to a predicted value, as shown in FIG. 3. Particularly, FIG. 3 discloses a portion 300 of a decision tree that includes a node 302. The node 302 corresponds to, or embodies, a particular inequality test whose only possible values are ‘True’ or ‘False,’ namely, fⱼ≥0.8. A new observation yᵢ follows a path in the decision tree 300 according to the respective values of the features of yᵢ. In this illustrative example, yᵢ has feature fⱼ=0.91. Because 0.91≥0.8, yᵢ takes the ‘True’ path 304 on the right of the node 302 inequality test fⱼ≥0.8. With respect to example embodiments, each feature f may comprise a competency score achieved by the observation, that is, by a candidate, for a particular area or skill.

In order to bring transparency to algorithmic pre-employment assessments as well as giving to their users the ability to evaluate how different new observations, that is, candidate, compare to the observations in the training dataset, that is, current employees, example embodiments of the invention may comprise the following stages: enrich the training stage with new functionalities; and, compute a diversity score for every new observation for which an output must be predicted. Note that as used herein, a new observation refers to an observation that is not part of the training dataset, for example, a job candidate who is not yet employed by the company that is evaluating that job candidate.

C.1 Enriching the Training Stage

During the training process, each node nᵢ in the decision tree that is being trained keeps track of the observations in the training dataset that reached that node, that is, those observations coming from one of the paths of its parent node. FIG. 4 illustrates an example implementation of this functionality. Particularly, when growing the decision tree 400, every node nᵢ. 402, 404, and 406, is mapped to a respective set 403, 405, and 407, of training observations mᵢ, which “comes” from one of the paths of its parent node. That is, during the training step, when building a new node, embodiments also keep a data structure ‘m’ that maps each node 402, 404, and 406 to the respective set of training observations that reached it, that is, those observations that reached that node from a parent to that node.

For example, in the tree 400 illustrated in FIG. 4, node nᵢ₊₂ 404 is mapped to the data structure mᵢ₊₂ 405 which is a set that contains representations of those training observations that reached the node 404, that is, those observations that satisfied the inequality test f₂≥v and, thus, traversed from node 402 to node 404. By comparison, an observation such as o₁ that did not satisfy, for example, the inequality test f₂≥v, would not pass to node 404 and would not, therefore, be included in the data structure mᵢ₊₂ 405 associated with node 404.

Recall that every node nᵢ is associated with an inequality test over a feature fⱼ. Given this, at the end of the training stage, example embodiments may calculate, for each node nᵢ in the tree, a probability distribution over the values o:fⱼ, in mᵢ. Such probability distributions, one of which may be generated for the respective feature associated with each node, may be constructed via any probability function fitting method, such as Gaussian fitting, or Gaussian Mixture fitting for more flexible probabilities. Once the probability distributions are constructed, their parameters may be stored. That is, for a Gaussian distribution, some embodiments would only require storage of the mean and variance as a pair of parameters. Thus, one pair of parameters may be stored for each node. In this way, example embodiments may be efficient in minimizing the extra data that may need to be stored.

C.2 Diversity Score Computation

In general, a diversity score (DS) may be computed for every new observation, that is, candidate, for which an output is needed and must be predicted. The diversity score can be computed after the new observation has traversed the decision tree and reached a leaf. In this regard, recall that a new observation is an observation that is note part of the training dataset, and the training dataset may comprise current employees of the company that is attempting to define a candidate pool. As discussed below, a local diversity score for a new observation may be generated for each node of a decision tree, and an aggregate or final diversity score may also be generated for a new observation after it has completely traversed the decision tree.

C.2.1—Local Diversity Score Computation

With all the probability distributions in hand, one for each node nᵢ in the tree, example embodiments may then compute a local diversity score LDS (yᵢ, nᵢ) for every new observation yᵢ with respect to each node nᵢ that is traversed by y. As noted earlier, each node nᵢ is associated with a respective inequality test with respect to a feature fⱼ.

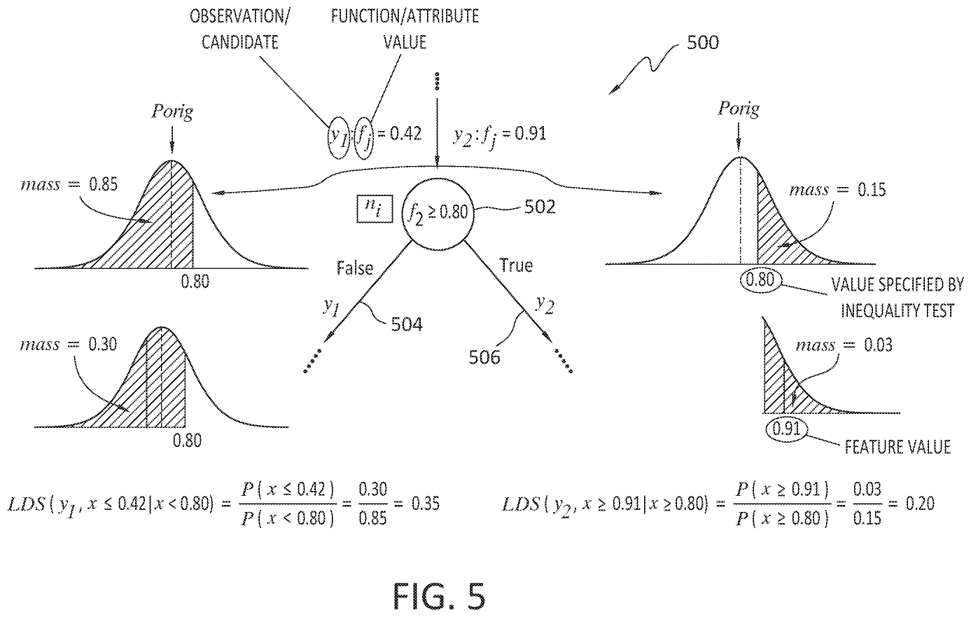

Reference is now made to FIG. 5, which discloses an example method and configuration 500 for calculating the LDS for two different new observations y₁ and y₂, for a given node nᵢ that is associated with an inequality test over fⱼ. In FIG. 5, the probability distribution calculated for node nᵢ during the training stage is denoted P_{orig}.

In the example of FIG. 5, the cut-off point of the illustrated node nᵢ, denoted at 502, is at 0.8, since the inequality test for that node 502 is fⱼ≥0.8. As shown, the cut-off point defines two different masses, which together total 1.0 since the inequality function is binary, at node nᵢ. The first mass of these two masses is associated with observations that followed the left path 504 of nᵢ during the training stage. Thus, the first mass has a value of 0.85. That is, a new observation whose value for the function f1 is not ≥0.8 can be said to be in the 85^{th} percentile for all of the new observations. The second mass of the two masses is associated with observations that followed the right path 506 of nᵢ. The second mass, in this example, has a value of 0.15. That is, a new observation whose value for the function f1 is ≥0.8 can be said to be in the 15^{th} percentile for all of the new observations.

It is noted that the mass for a given interval is calculated as the definite integral of the probability density function over the interval. At least some example embodiments may employ commonplace probability functions, such as a normal distribution with a Gaussian function, for example, for which closed-form integrals are known and easy to calculate. Therefore, masses may be calculated relatively easily without any extra significant computational costs, at least in terms of processing.

With continued reference to FIG. 5, consider the two new observations, y₁ and y₂, which traverse the trained decision tree. Since y₂: f₁=0.91, which is ≥0.8, y₂ will follow the right path 506 of nᵢ, whose mass is 0.15, as noted earlier. In order to calculate the local diversity score for nᵢ, that is, LDS(y₂,nᵢ), a computation may be performed to determine how much of such mass 0.15 is situated to the right of 0.91. As noted earlier 0.91 is the value of feature f₁ for the observation.

Put another way, the inquiry at this point is, for all observations whose f₁ has a value ≥0.8, what portion of those observations correspond to a value ≥0.91. Satisfying this inquiry will produce the percentile of the new observation y₂ with respect to all new observations that have entered the tree. In this example, the amount of mass situated to the right of 0.91, in the probability distribution, is computed to be 0.03. That is, because the new observation y₂ has an f₁ value ≥0.91, the new observation y₂ is in the 3^{rd} percentile of all the new observations.

After the mass situated to the right of 0.91 in the probability distribution has been calculated, that mass of 0.03 may then be normalized as follows:

$$L D S ( {y}_{2} , {n}_{i} ) = \frac{0.03}{0.15} = 0.20$$

Now, since y₁:fⱼ=0.42, it will follow the left path 504 of nᵢ, whose mass is 0.85, and LDS(y₁,nᵢ) is calculated in the same way as LDS(y₂,nᵢ), namely:

$$L D S ( {y}_{1} , {n}_{i} ) = \frac{0.30}{0.85} = 0.35$$

where 0.30 is the mass on the left of 0.42.

C.2.2—Observation Diversity Score Computation

When all of the local diversity scores (LDS) have been determined for a new observation, those local diversity scores may then be used, in various ways, to calculate an aggregate or overall diversity score for that new observation. In general, the overall diversity score may reflect, for a given new observation y, how different that observation is with respect to a set of training data.

Thus, a relatively high diversity score may indicate that the new observation y conforms relatively closely to the training data, while a relatively low diversity score may indicate that the new observation does not closely conform to the training data. A hiring decision may be made that is based on the diversity score achieved by a candidate. For example, in the interest of creating a candidate pool that is relatively diverse, as measured by one or more subjective criteria and/or objective criteria, an organization may only consider candidates whose diversity score is relatively low, since such a diversity score may tend to indicate that the candidate materially differs from current employees in one or more regards. A low diversity score may indicate, for example, that a candidate has performed substantially better on a battery of competency tests than most current employees and, in that respect at least, the candidate may differ significantly from the current employees. As another example, a high diversity score may provide adequate, and demonstrable, justification for hiring, or at least considering for hire, the candidate to whom that diversity score corresponds. Further, a decision tree may be constructed to include whatever functions, and groups of functions, are of interest or relevance to the organization, while omitting functions that are not of interest or relevance to the organization. Finally, a diversity score may indicate an extent to which candidate competencies match up with the competencies of a group of current employees. In this example, a relatively high diversity score may indicate that the candidate scored close to the current employees and as such is predicted to perform well, and a relatively low diversity score may indicate that the candidate did not score as well as the current employees and as such is not predicted to perform as well as current employees.

For example, note that when a new observation y runs through the decision tree, the new observation y traverses a particular path starting from the root of the tree, passing through a subset of nodes {n₁ . . . nₚ}, and ultimately arriving at a leaf of the tree. Thus, embodiments may then calculate a respective LDS score for each node traversed by y, and then aggregate all the results, that is, the individual LDS scores for the nodes, into a single diversity score DS(y). This aggregation process of individual LDS scores may be performed in various ways.

One example of an aggregation approach is to use the mean of all LDS scores across the path traveled by y:

$$D S ( y ) = \frac{1}{P} {\sum }_{i = 1}^{P} L D S ( y , {n}_{i} )$$

Note however that embodiments of the invention are not limited to using the mean as the aggregation function. Other options for an aggregation function include the log-likelihood mean

$$\frac{1}{P} {\prod }_{i = 1}^{P} log L D S ( y , {n}_{i} ) ,$$

among others. More generally, any aggregation function usable to summarize the LDS scores into a single value may be employed in embodiments of the invention.

Note that the lower DS(y), the more diverse y is with respect to the observations that trained the model. DS(y) may also indicate how confident the decision tree model is with respect to the prediction. The lower the value of DS(y), the lower the confidence in the prediction made by the decision tree model.

Finally, it is also possible to go further and calculate DS for each new observation in a given data set, for example, a set of new candidates for a job. This would result in creation of an array of diversity scores, where each element represents the diversity score for each of the new observations. Finally, example embodiments of the invention may chart the distribution of the value(s) of this array in order to analyze the diversity of a set of new observations, instead of analyzing the diversity of only a single new observation.

D. Further Discussion

As will be apparent from this disclosure, example embodiments may possess a variety of useful features and functions. For example, an embodiment may provide for application of self-explaining machine learning models in algorithmic hiring. Some particular embodiments may employ decision trees as a mechanism to bring explainability, and consequently, transparency, to algorithm-based hiring. As another example, embodiments may provide for application of outlier detection for quantifying diversity and confidence in algorithmic hiring. Further, embodiments may apply outlier detection, as a mechanism to quantify diversity in algorithmic hiring processes. Finally, example embodiments may implement a framework that allows for the computation of a diversity score, which may also be regarded as a confidence score in at least some embodiments, for every observation for which a prediction is made by the ML model.

E. Example Methods

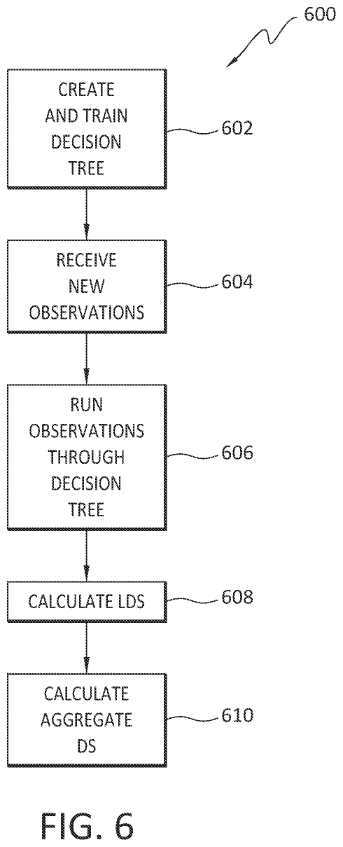

It is noted with respect to the example method of FIG. 6 that any of the disclosed processes, operations, methods, and/or any portion of any of these, may be performed in response to, as a result of, and/or, based upon, the performance of any preceding process(es), methods, and/or, operations. Correspondingly, performance of one or more processes, for example, may be a predicate or trigger to subsequent performance of one or more additional processes, operations, and/or methods. Thus, for example, the various processes that may make up a method may be linked together or otherwise associated with each other by way of relations such as the examples just noted. Finally, and while it is not required, the individual processes that make up the various example methods disclosed herein are, in some embodiments, performed in the specific sequence recited in those examples. In other embodiments, the individual processes that make up a disclosed method may be performed in a sequence other than the specific sequence recited.

Directing attention now to FIG. 6, an example method 600 according to some embodiments is disclosed. While the method 600, nor any portion of it, is required to be performed by any particular entity, in at least some embodiments, the method 600 may be embodied in the form of executable instructions carried on a non-transitory storage medium which may be an element of a computing entity such as a server for example. In some embodiments, such as server or other computing entity may include assessment software to test and evaluate the performance of candidates with respect to one or more fields of competency. The assessment software may be hosted on an entity other than the entity that hosts the aforementioned executable instructions. More generally, no particular configuration of hardware and/or software is required to implement embodiments of the invention.

Turning now to FIG. 6, the example method 600 may begin with the creation and training 602 of a decision tree. Each node of the tree may correspond to a particular function, such as a task competency for example. The decision tree may be trained using a dataset comprising, for example, prior observations such as known competency scores of one or more individuals.

Upon completion of the decision tree, new observations may be received 604. The new observations may be received directly by the tree, or by an intermediary that directs the new observations to the decision tree. In some embodiments, a new observation corresponds to a particular job candidate.

The new observations may then traverse 606 the nodes of the decision tree, beginning at a root node of the decision tree. In at least some embodiments, the new observations may run through the decision tree 606 until one or more of the new observations reaches a leaf of the decision tree.

After the observations have been run 606 through the decision tree, or while the observations are traversing the decision tree, an LDS may be calculated 608 for each node traversed by an observation. The LDS values may then be aggregated 610 together to define an overall DS for the observation. The DS may be used, for example, to make a hiring decision, or to predict whether a particular job candidate will be successful.

F. Further Example Embodiments

Following are some further example embodiments of the invention. These are presented only by way of example and are not intended to limit the scope of the invention in any way.

Embodiment 1. A method, comprising: receiving, at a decision tree trained with a group of training observations, a group of new observations; traversing the decision tree with the new observations; calculating, for one or more nodes of the decision tree, a respective local diversity score; and aggregating the local diversity scores to create an aggregate diversity score, and the aggregate diversity score indicates an extent to which one or more of the new observations are similar, in one or more respects, to the group of training observations.

Embodiment 2. The method as recited in embodiment 1, wherein the group of training observations comprises respective competency scores for each employee in a group of employees, and the new observations correspond to respective job candidates.

Embodiment 3. The method as recited in any of embodiments 1-2, wherein the decision tree comprises a plurality of nodes, and each of the nodes corresponds to a respective inequality test over a function fᵢ.

Embodiment 4. The method as recited in any of embodiments 1-3, wherein a path followed by one of the new observations through the decision tree ends at a leaf whose value comprises a prediction of a performance score for that new observation.

Embodiment 5. The method as recited in any of embodiments 1-4, further comprising, prior to the receiving, constructing the decision tree, and the decision tree comprises a plurality of nodes.

Embodiment 6. The method as recited in embodiment 5, further comprising traversing the nodes of the decision tree with each of the training observations and, after the traversing, mapping each of the nodes to a respective subset of the training observations.

Embodiment 7. The method as recited in embodiment 6, wherein each subset of the training observations comprises those training observations which have traversed the node to which that subset corresponds.

Embodiment 8. The method as recited in embodiment 5, further comprising calculating, for each node, a respective probability distribution for an inequality test associated with that node.

Embodiment 9. The method as recited in embodiment 8, wherein the probability distribution for a node includes inequality test values for each training observation that traversed that node.

Embodiment 10. The method as recited in any of embodiments 1-9, wherein each local diversity score is specific to a particular new observation and is based on: a minimum value needed to satisfy an inequality test associated with the node to which the local diversity score corresponds; and, an inequality test value specific to the particular new observation.

Embodiment 11. A system for performing any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

G. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

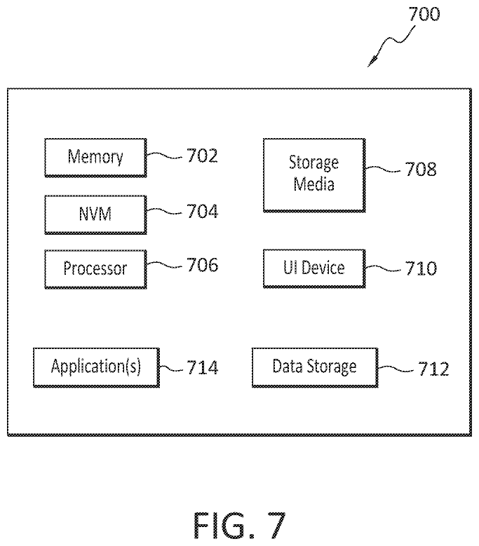

With reference briefly now to FIG. 7, any one or more of the entities disclosed, or implied, by FIGS. 1-6 and/or elsewhere herein, may take the form of, or include, or be implemented on, or hosted by, a physical computing device, one example of which is denoted at 700. As well, where any of the aforementioned elements comprise or consist of a virtual machine (VM), that VM may constitute a virtualization of any combination of the physical components disclosed in FIG. 7.

In the example of FIG. 7, the physical computing device 700 includes a memory 702 which may include one, some, or all, of random access memory (RAM), non-volatile memory (NVM) 704 such as NVRAM for example, read-only memory (ROM), and persistent memory, one or more hardware processors 706, non-transitory storage media 708, UI device 710, and data storage 712. One or more of the memory components 702 of the physical computing device 700 may take the form of solid state device (SSD) storage. As well, one or more applications 714 may be provided that comprise instructions executable by one or more hardware processors 706 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
receiving, at a decision tree trained with a group of training observations, a group of new observations;
traversing the decision tree with the new observations;
calculating, for one or more nodes of the decision tree, a respective local diversity score; and
aggregating the local diversity scores to create an aggregate diversity score, and the aggregate diversity score indicates an extent to which one or more of the new observations are similar, in one or more respects, to the group of training observations.

2. The method as recited in claim 1, wherein the group of training observations comprises respective competency scores for each employee in a group of employees, and the new observations correspond to respective job candidates.

3. The method as recited in claim 1, wherein the decision tree comprises a plurality of nodes, and each of the nodes corresponds to a respective inequality test over a function fᵢ.

4. The method as recited in claim 1, wherein a path followed by one of the new observations through the decision tree ends at a leaf whose value comprises a prediction of a performance score for that new observation.

5. The method as recited in claim 1, further comprising, prior to the receiving, constructing the decision tree, and the decision tree comprises a plurality of nodes.

6. The method as recited in claim 5, further comprising traversing the nodes of the decision tree with each of the training observations and, after the traversing, mapping each of the nodes to a respective subset of the training observations.

7. The method as recited in claim 6, wherein each subset of the training observations comprises those training observations which have traversed the node to which that subset corresponds.

8. The method as recited in claim 5, further comprising calculating, for each node, a respective probability distribution for an inequality test associated with that node.

9. The method as recited in claim 8, wherein the probability distribution for a node includes inequality test values for each training observation that traversed that node.

10. The method as recited in claim 1, wherein each local diversity score is specific to a particular new observation and is based on: a minimum value needed to satisfy an inequality test associated with the node to which the local diversity score corresponds; and, an inequality test value specific to the particular new observation.

11. A non-transitory storage medium having stored therein instructions that are executable by one or more hardware processors to perform operations comprising:
receiving, at a decision tree trained with a group of training observations, a group of new observations;
traversing the decision tree with the new observations;
calculating, for one or more nodes of the decision tree, a respective local diversity score; and
aggregating the local diversity scores to create an aggregate diversity score, and the aggregate diversity score indicates an extent to which one or more of the new observations are similar, in one or more respects, to the group of training observations.

12. The non-transitory storage medium as recited in claim 11, wherein the group of training observations comprises respective competency scores for each employee in a group of employees, and the new observations correspond to respective job candidates.

13. The non-transitory storage medium as recited in claim 11, wherein the decision tree comprises a plurality of nodes, and each of the nodes corresponds to a respective inequality test over a function fᵢ.

14. The non-transitory storage medium as recited in claim 11, wherein a path followed by one of the new observations through the decision tree ends at a leaf whose value comprises a prediction of a performance score for that new observation.

15. The non-transitory storage medium as recited in claim 11, wherein the operations further comprise, prior to the receiving, constructing the decision tree, and the decision tree comprises a plurality of nodes.

16. The non-transitory storage medium as recited in claim 15, wherein the operations further comprise traversing the nodes of the decision tree with each of the training observations and, after the traversing, mapping each of the nodes to a respective subset of the training observations.

17. The non-transitory storage medium as recited in claim 16, wherein each subset of the training observations comprises those training observations which have traversed the node to which that subset corresponds.

18. The non-transitory storage medium as recited in claim 15, wherein the operations further comprise calculating, for each node, a respective probability distribution for an inequality test associated with that node.

19. The non-transitory storage medium as recited in claim 18, wherein the probability distribution for a node includes inequality test values for each training observation that traversed that node.

20. The non-transitory storage medium as recited in claim 11, wherein each local diversity score is specific to a particular new observation and is based on: a minimum value needed to satisfy an inequality test associated with the node to which the local diversity score corresponds; and, an inequality test value specific to the particular new observation.
